(19) United States
(12) Patent Application Publication
(10) Pub. No.: US 2006/0237632 A1
(43) Pub. Date: Oct. 26, 2006

(54) Optical sensor and method of manufacturing the same

(75) Inventor: Koji Niioka, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/391,419

(22) Filed: Mar. 29, 2006

(30) Foreign Application Priority Data
Mar. 29, 2005 (JP) 2005-094779

(51) Int. Cl. H01J 40/14

(52) U.S. Cl. 250/214 R

(57) ABSTRACT

In order to manufacture an optical sensor, it is measured a sensitivity of a sensor element provided with a photo emitter operable to emit light and a photo receiver operable to output a current in accordance with an amount of received light. A resistor is selected in accordance with the measured sensitivity. The resistor is connected to a circuit operable to drive the optical sensor.

### BACKGROUND OF THE INVENTION

The present invention relates to an optical sensor and a method of manufacturing the same.

For example, some printing apparatuses such as ink jet printers, etc. use an optical sensor in order to detect presence and absence of a printing sheet, sheet width, or the like (see Japanese Patent Publication No. 5-131729A).

Optical sensors involve dispersion in sensitivity, so that in some cases detection of a printing sheet becomes difficult with a low sensitivity and other portions than a printing sheet is erroneously detected as a printing sheet with a high sensitivity. Accordingly, since it is necessary to select and use an optical sensor, of which sensitivity falls within a predetermined range, a decrease in yield is caused with the result that there is caused a problem of a high manufacturing cost.

### SUMMARY OF THE INVENTION

It is therefore an object of the invention to provide an optical sensor and a method of manufacturing the same, in which an improvement in yield is enabled.

In order to achieve the above object, according to the invention, there is provided a method of manufacturing an optical sensor, comprising:

measuring a sensitivity of a sensor element comprising a photo emitter operable to emit light and a photo receiver operable to output a current in accordance with an amount of received light;

selecting a resistor in accordance with the measured sensitivity; and

connecting the resistor to a circuit operable to drive the optical sensor.

The sensitivity may be measured by measuring the current when the photo emitter emits the light under a predetermined condition.

The method may further comprise classifying the sensor element into one of a plurality of groups in accordance with the measured sensitivity. Each of the groups may be associated with one resistance. The resistor may be so selected as to have the resistance associated with one of the group to which the sensor element is classified.

The resistor may be connected to the photo emitter in series.

The sensor element and the resistor is mounted on a printed board on which the circuit is formed.

According to the invention, there is also provided an optical sensor, manufactured by the above method.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of an inside of a printer according to one embodiment of the invention;

FIG. 2A is a schematic side view showing a positional relationship among a carriage, a printing sheet and a platen in the printer;

FIG. 2B is a schematic plan view showing the positional relationship;

FIG. 3A is a circuit diagram of an optical sensor in the printer;

FIG. 3B is a schematic view showing the optical sensor and a marker provided on the disk tray;

FIG. 4 is a block diagram showing a control system of the printer;

FIG. 5 is a diagram showing dispersion in sensitivity of the optical sensor;

FIG. 6A is a diagram showing the detection of the printing sheet in a case where the sensitivity of the optical sensor is normal;

FIG. 6B is a diagram showing the detection of the printing sheet in a case where the sensitivity of the optical sensor is low;

FIG. 7 is a diagram showing the detection of the printing sheet in a case where the sensitivity of the optical sensor is high;

FIG. 8 is a flowchart showing a method of manufacturing the optical sensor; and

FIG. 9 is a perspective view of the optical sensor.

### DETAILED DESCRIPTION OF THE EMBODIMENTS

Embodiments of the invention will be described below in detail with reference to the accompanying drawings.

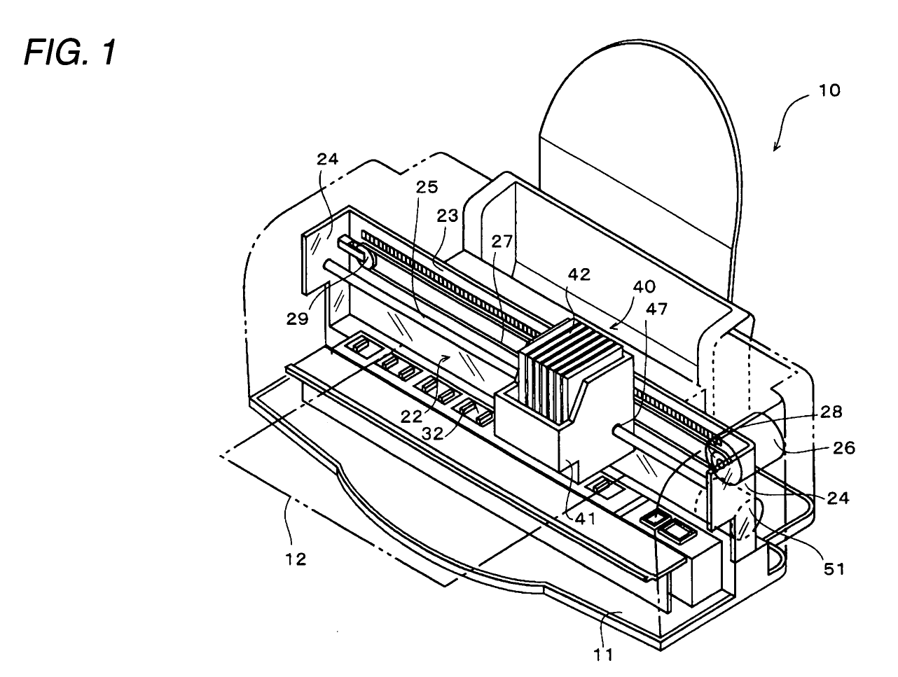

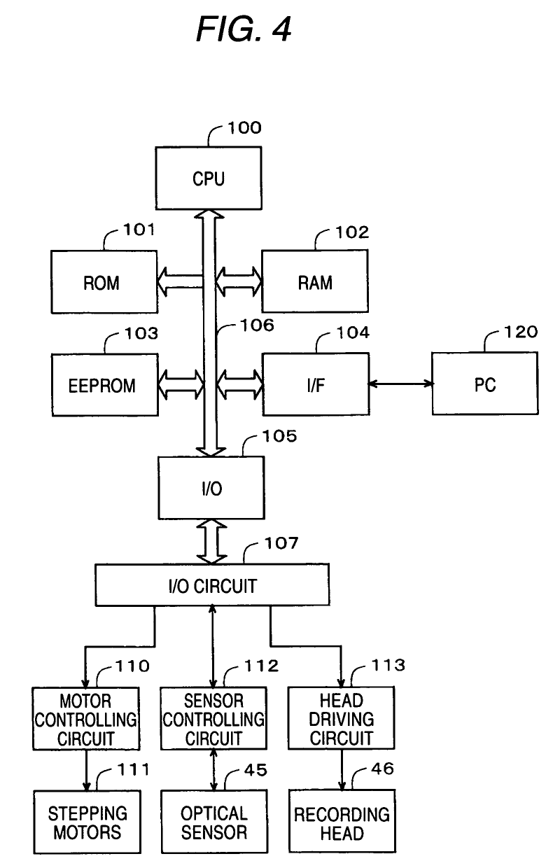

A printing apparatus referred to in this specification comprehends a printer 10 shown in FIG. 1, or a combination of the printer 10 and a personal computer 120 shown In FIG. 4. The printer 10 comprises a chassis 11, and a carriage 40 which is reciprocately movable relative to the chassis 11 in a primary scanning direction.

The carriage 40 comprises an ink cartridge 42 that stores black ink and color ink (yellow, cyan, magenta, etc.), and a mounting part 41 that mounts the ink cartridge. A recording head (not shown) is provided below the mounting part 41 to be opposed to a printing sheet 12. A lower end face of the recording head defines a nozzle formation face, from which ink can be ejected.

A part of a timing belt 27 is fixed to the mounting part 41. Also, the mounting part 41 is formed with an insertion hole 47, through which an elongated guide shaft 25 can be inserted. The timing belt 27 is stretched between a drive pulley 28 of a carriage motor 26, and a follower pulley 29. Accordingly, when the carriage motor 26 rotates, the timing belt 27 is driven and the carriage 40 is moved along the guide shaft 25. At this time, since an encoder 43 outputs a signal corresponding to a position of the carriage 40, it is possible to know the position of the carriage 40 with reference to the signal.

A platen 32 having a plurality of ribs is provided in a position opposed to the nozzle formation face of the carriage 40 on the chassis 11, and the printing sheet 12 is conveyed above the ribs. Provided on an upstream side (a side, to which a printing sheet is fed) of the chassis 11 is a support frame 22 having a shielding plate portion 23 and side plate portions 24 on both ends of the shielding plate portion 23 to be bent toward a downstream side (a side, from which a printing sheet is ejected). Fixed to the side plate portions 24 are the driven pulley 29, around which the timing belt 27 is stretched, and the guide shaft 25. The carriage motor 26 is fixed to the shielding plate portion 23.

A sheet feeding motor 51 is provided on an upstream side of the shielding plate portion 23, a roller 20 is provided and rotated whereby the printing sheet 12 is moved in the secondary scanning direction.

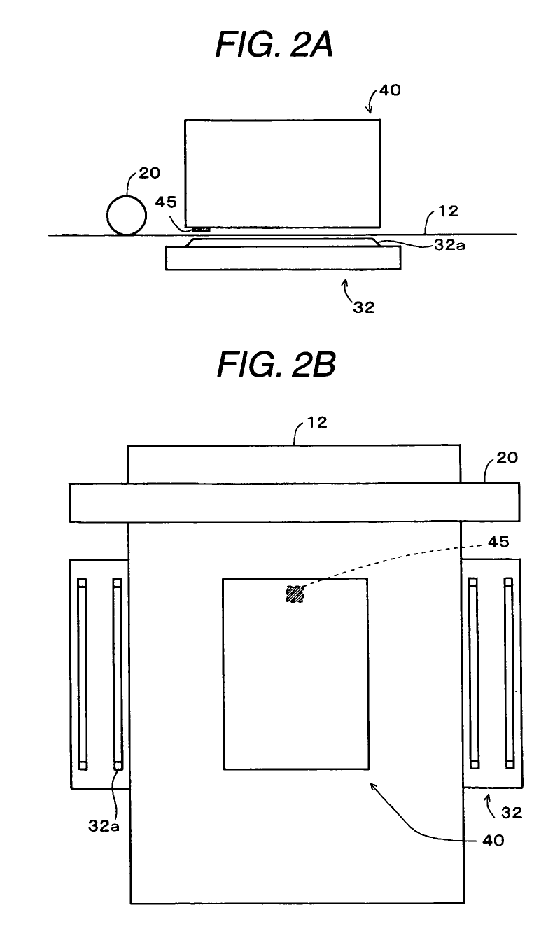

As shown in FIG. 2A, the carriage 40 is provided in a position opposed to the platen 32 with the printing sheet 12 therebetween. A plurality of ribs 32a are provided on a top of the platen 32, and the printing sheet 12 is conveyed above the ribs 32a by the roller 20. An optical sensor 45 is provided on a bottom face of the carriage 40 to detect the presence or absence of the printing sheet 12 and a width of the printing sheet 12.

As shown in FIG. 2B, the plurality of ribs 32a are provided on the top of the platen 32. Also, the optical sensor 45 is provided on the bottom face of the carriage 40 on an upstream side to detect a position of a marker.

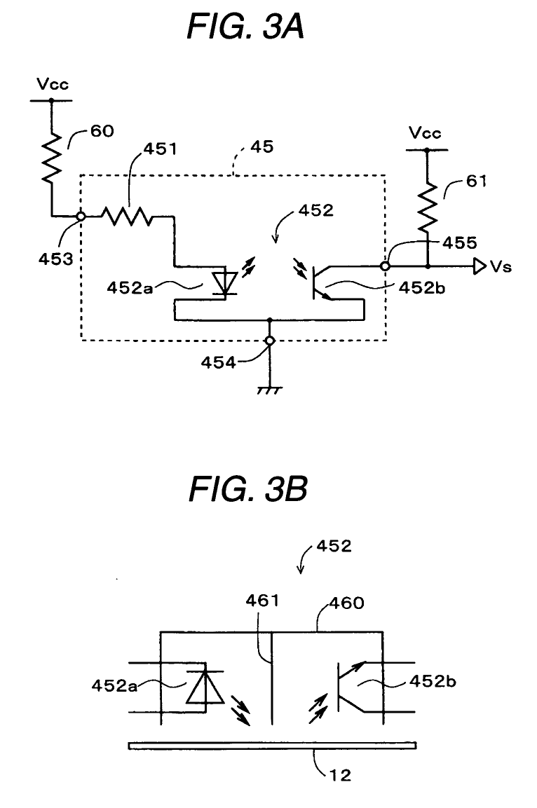

As shown in FIG. 3A, the optical sensor 45 comprises an optical sensor element 452. The optical sensor element 452 comprises a photo emitter 452a and a photo receiver 452b to irradiate light on the printing sheet 12 to convert intensity of a reflected light into corresponding electric signals to output the same. Here, the photo emitter 452a is formed from, for example, a light emitting diode or the like to emit infrared rays. The photo receiver 452b is formed from, for example, a phototransistor or the like to permit a reflected light, which is emitted from the photo emitter 452a and reflected by the printing sheet 12, to be made incident thereupon, and thus is changed in resistance corresponding to the intensity of reflected light. In addition, the photo receiver 452b comprises, at a light incident part, a filter that attenuates visible light in order to lessen influences of ambient light (mainly, visible light).

In this embodiment, a resistor 451 is connected in series to a resistor 60 included in an sensor controlling circuit described later to adjust an electric current flowing through the photo emitter 452a, thereby adjusting the sensitivity of the optical sensor element 452. In addition, an optimum resistor is selected according to the sensitivity of the optical sensor element 452 to be used as the resistor 451 in a manufacturing process as described later.

The optical sensor element 452 is placed on, for example, a printed board, and connects thereto terminals 453, 454, 455 provided on the printed board, and an electric source and grounding of the printer 10. That is, the terminal 453 is connected to an anode of the photo emitter 452a, the terminal 453 being connected to one end of a resistor 60 arranged in a sensor controlling circuit 112 (described later) of the printer 10. Also, the terminal 454 is connected to a cathode side of the photo emitter 452a, an emitter side of the photo receiver 452b, and grounding of the sensor controlling circuit 112. Also, the terminal 455 is connected to a collector side of the photo receiver 452b and a resistor 61 arranged in the sensor controlling circuit 112.

As shown in FIG. 3B, the optical sensor element 452 comprises the photo emitter 452a and the photo receiver 452b, both of which are placed inside a housing 460 with a partition 461. Here, the housing 460 prevents an ambient light from being incident upon the photo receiver 452b. The partition 461 prevents light, which is emitted from the photo emitter 452a, from being made incident directly upon the photo receiver 452b. As shown in FIG. 3B, when the markers 62a to 66a being detected objects are present, light emitted from the photo emitter 452a is reflected by surfaces of the markers 62a to 66a to be made incident upon the photo receiver 452b. As a result, the photo receiver 452b is activated and an electric current flows through the resistor 61 from an electric source Vcc, so that Vs being an output voltage is put in a low state. On the other hand, when the markers 62a to 66a are not present, a reflected light is not made incident upon the photo receiver 452b and the photo receiver 452b is deactivated, so that an output voltage Vs is put In a high state.

Subsequently, an explanation will be given to a control system of the printer 10 shown in FIG. 1. As shown in FIG. 4, the control system of the printer 10 comprises a CPU (Central Processing Unit) 100, a ROM (Read Only Memory) 101, a RAM (Random Access Memory) 102, a EEPROM (Electrically Erasable and Programmable ROM) 103, an I/F (interface) 104, an I/O (Input and Output) unit 105, a bus 106, an I/O circuit 107, a motor controlling circuit 110, stepping motors 111, the sensor controlling circuit 112, the optical sensor 45, a head driving circuit 113, and a recording head 46, and the personal computer (PC) 120 is connected to the I/F 104.

Here, the CPU 100 executes various arithmetic processings according to programs stored in the ROM 101 and the EEPROM 103 and controls respective parts of the apparatus including the stepping motors 111.

The ROM 101 comprises a semiconductor memory that stores various programs executed by the CPU 100 and various data.

The RAM 102 comprises a semiconductor memory that temporarily stores programs executed by the CPU 100 and data.

The EEPROM 103 comprises a semiconductor memory, in which predetermined data obtained as a result of the arithmetic processings in the CPU 100 are stored and the data are held also after the electric source of the printer 10 is interrupted.

The I/F 104 comprises a device for appropriate conversion of the form of data presentation when it gives and receives information from the personal computer 120. The I/O 105 comprises a device that gives and receives information from the Input/output circuit 107.

The bus 106 comprises a signal conductor group that connects the CPU 100, the ROM 101, the RAM 102, the EEPROM 103, the I/F 104, and the I/O 105 mutually and enables giving and receiving information among these elements.

The motor controlling circuit 110 comprises, for example, a logic circuit and a drive circuit and controls the stepping motors 111 according to control by the CPU 100.

The stepping motors 111 comprises, for example, the carriage motor 26 and the sheet feeding motor 51 and drives the carriage 40 and the roller 20 according to control by the motor controlling circuit 110.

The sensor controlling circuit 112 is one that controls the optical sensor 45 and comprises the resistors 60, 61 shown in FIG. 3A and a buffer, which supplies the output voltage Vs from the optical sensor 45 to the input/output circuit 107.

The optical sensor 45 detects the presence or absence of the printing sheet 12 and the width of the printing sheet 12 as described above with reference to FIGS. 3A and 3B.

The head driving circuit 113 comprises a driver connected to the recording head 46, which executes a recording processing on the printing sheet 12, and exercises control of a recording processing on the recording head 46. As described above, the recording head 46 ejects ink of various colors from the plurality of nozzles according to control by the head driving circuit 113 and prints desired images and texts on the printing sheet 12.

Subsequently, an explanation will be given to a method of manufacturing the optical sensor 45. After an explanation is given to the necessity of adjusting the sensitivity of the optical sensor 45, a method of manufacturing the optical sensor 45 will be described below.

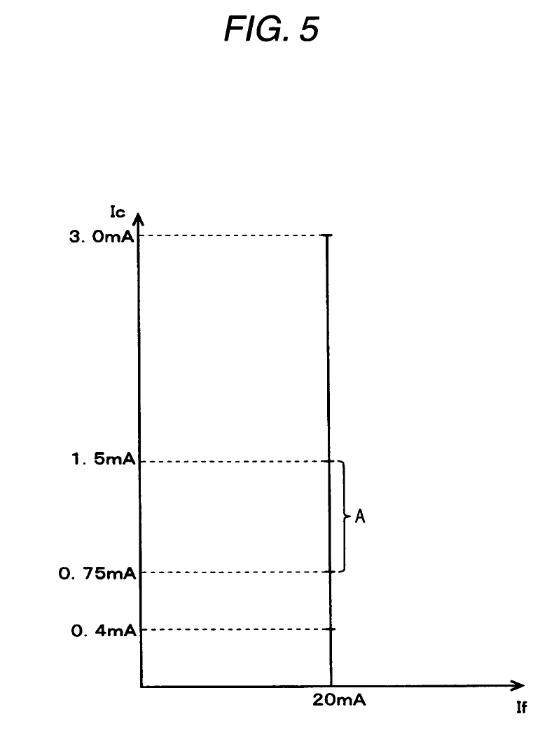

FIG. 5 shows dispersion, between the elements, in an electric current If flowing through the photo emitter 452a and an electric current Ic flowing through the photo receiver 452b in the case where the optical sensor element 452 is measured individually (in the case where the resistor 451 is not connected thereto). As shown in figure, in the case where the electric current if flowing through the photo emitter 452a is set to 20 mA, the electric current Ic flowing through the photo receiver 452b is distributed in the range of 0.4 mA to 3.0 mA. Here, in the case where the electric current Ic flowing through the photo receiver 452b is large, the optical sensor element 452 is high in sensitivity, and on the other hand, in the case where the electric current Ic is small, the optical sensor element 452 is low in sensitivity. “A” denotes a range, in which use as the optical sensor 45 is possible in the case where the sensitivity is not adjusted (in the case where the resistor 451 is not connected).

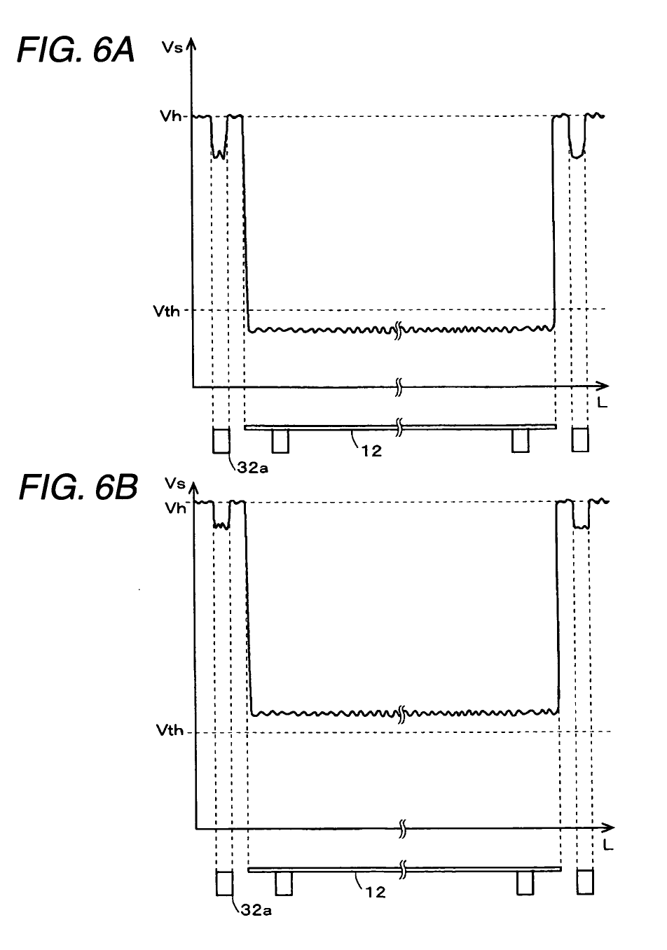

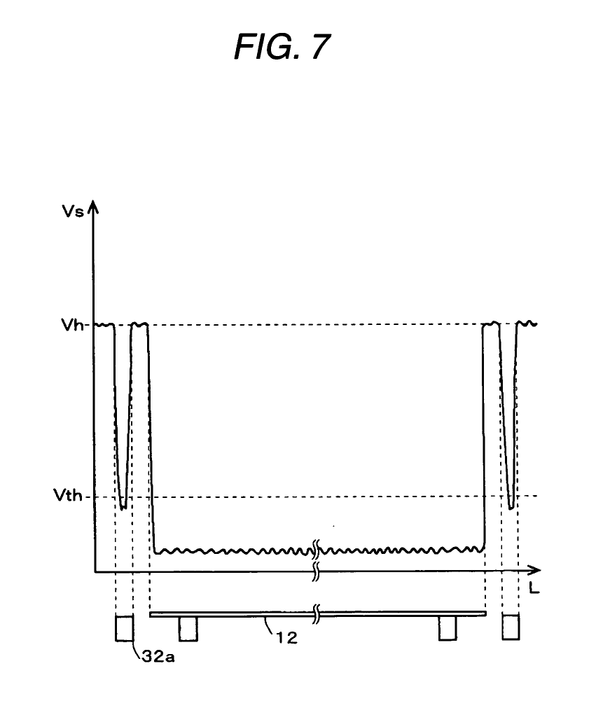

FIGS. 6A through 7 show how the output voltage Vs is changed according to high and low sensitivities in the case where a jumper wire is used in place of the resistor 451 in the circuit shown in FIG. 3A and detects a printing sheet 12.

FIG. 6A is a view showing the relationship between a position L of the optical sensor 45 and an output voltage Vs in the case where the sensitivity is appropriate (in the case where Ic is within the range A shown In FIG. 5). The output voltage Vs of the optical sensor 45 is put in a low state to correspond to a location, in which a printing sheet 12 is present, and put in a high state to correspond to other locations. Also, the output voltage Vs is put in a little lower state than the high state to correspond to locations, in which the ribs 32a of the platen 32 are existent. This is because top faces of the ribs 32a are formed close to the optical sensor 45 and therefore a part of reflected light is incident upon the photo receiver 452b. In such case, the sensor controlling circuit 112 sets a voltage as high as around 30% of a high voltage Vh as a threshold voltage Vth to judge that a printing sheet 12 is present when the output voltage Vs is lower than the threshold voltage Vth and that a printing sheet 12 is absent when the output voltage is larger than the threshold voltage Vth.

FIG. 6B is a view showing the relationship between a position L of the optical sensor 45 and an output voltage Vs in the case where the sensitivity is low (In the case where Ic is smaller than range A shown in FIG. 5). The output voltage Vs of the optical sensor 45 is put in a low state to correspond to a location, in which a printing sheet 12 is present, and put in a high state to correspond to other locations, in the same manner as in the case shown in FIG. 6A. Also, the output voltage Vs is put in a little lower state than the high state to correspond to locations, in which the ribs 32a of the platen 32 are existent. In this case, however, when the threshold voltage Vth is set to around 30% of a high voltage Vh, the threshold voltage Vth becomes larger than that in the low state, so that it becomes not possible to detect a printing sheet 12.

FIG. 7 is a view showing the relationship between a position L of the optical sensor 45 and an output voltage Vs in the case where the sensitivity is high (in the case where Ic is larger than range A shown in FIG. 5). The output voltage Vs of the optical sensor 45 is put in a low state to correspond to a location, in which a printing sheet 12 is present, and put in a high state to correspond to other locations, in the same manner as in the case shown in FIG. 6A. Also, since a voltage in a low state is lower than the threshold voltage Vth, it is possible to detect a printing sheet 12. In this case, however, an output voltage Vs falls below the threshold voltage Vth even in locations, in which the ribs 32a of the platen 32 are existent. Consequently, the ribs 32a are detected as a sheet end of the printing sheet 12, so that a sheet width is erroneously detected.

In this embodiment, in a method of manufacturing the optical sensor 45, by connecting the resistor 451 conformed to the sensitivity of the optical sensor element 452, and adjusting the sensitivity through adjustment of intensity of light irradiated by the photo emitter 452a, thereby causing the optical sensor 45 to perform a normal operation as shown in FIG. 6A.

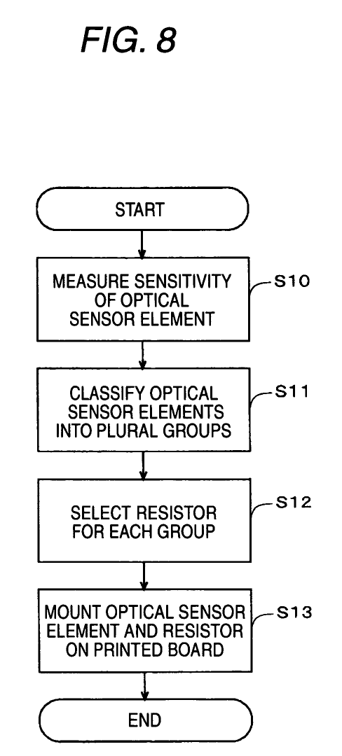

An explanation will be given below to details of the method of manufacturing an optical sensor with reference to FIG. 8.

STEP S10: The sensitivity of the single optical sensor element 452 is measured. In addition, a method of measuring the sensitivity comprises first connecting a predetermined loading resistor (for example, a resistor of 3.3 kΩ) to a collector of the photo receiver 452b and applying a predetermined source voltage (for example, a source voltage of 3.3 V) to the loading resistor to bring about a state, in which a predetermined electric current (for example, an electric current of 20 mA) flows through the photo emitter 452a. In such state, a printing sheet (for example, a mat sheet) having a predetermined reflection coefficient is opposed to the optical sensor element 452, and at that time, an electric current Ic flowing through the photo receiver 452b is measured.

STEP S11: On the basis of measurement results in STEP S10, the optical sensor elements 452 are classified into a plurality of groups. Specifically, the optical sensor elements are classified into any one of a first group with Ic being less than 0.75 mA, a second group with Ic being not less than 0.75 mA but less than 1.5 mA, a third group with Ic being not less than 1.5 mA but less than 2.0 mA, a fourth group with Ic being not less than 2.0 mA but less than 2.5 mA, and a fifth group with Ic being not less than 2.5 mA. In addition, this grouping is exemplary, and is not limited to such case.

STEP S12: According to the groups thus classified, predetermined resistors are selected. For example, since the second group can be used without addition of the resistor 451, a resistor (a jumper wire) having a value of resistance of 0Ω is selected. A resistor of 30Ω is selected for the third group, a resistor of 60Ω is selected for the fourth group, and a resistor of 100Ω is selected for the fifth group. In addition, since the first group is too low In sensitivity, the optical sensor elements 452 belonging to this group are omitted from the ones to be used.

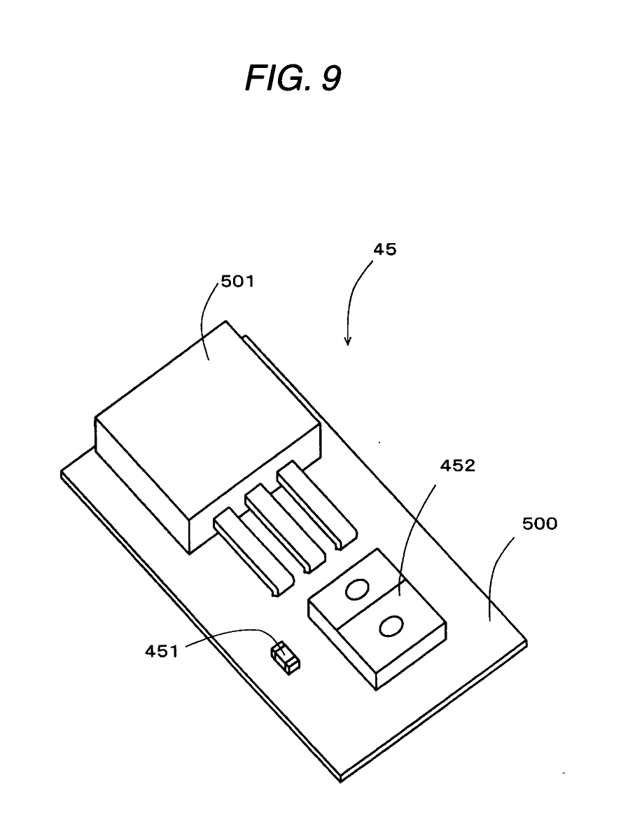

STEP S13: the Optical sensor element 452 is fixed, by soldering, to a printed board having a pattern corresponding to the circuit surrounded by dashed lines in FIG. 3A, and the resistor (for example, a chip resistor) 451 selected in STEP S12 is likewise fixed, by soldering, to the printed board 500 as shown in FIG. 9.

The optical sensor 45 is structured such that the optical sensor element 452, the resistor 451, and a connector 501 are fixed to the printed board 500 by soldering. Here, the connector 501 comprises terminals 453 to 455 shown in FIG. 3A, the connector 501 affording connection to the sensor controlling circuit 112. The resistor 451 is a chip resistor having a value of resistance selected in STEP S12, In addition, although not shown in the figure, a wiring pattern is formed on the printed board 500, and a circuit shown in FIG. 3A is constructed by connecting the connector 501, the optical sensor element 452, and the resistor 451 to the wiring pattern by soldering.

Since the optical sensor 45 manufactured thus is constant in sensitivity, it presents characteristic shown in FIG. 6A when mounted to the printing apparatus 10, so that it becomes possible to correctly detect presence and absence of a printing sheet 12 and a sheet width thereof.

Since the processes described above enables use of the third to fifth groups, which cannot be used because of being high in sensitivity as they are, it is possible to enhance the optical sensor elements 452 in yield, thus enabling reduction in manufacturing cost.

Since the optical sensor elements 452 are classified into a predetermined number of groups according to sensitivity and the resistors 451 are selected corresponding to the respective groups, small kinds of resistors as prepared are enough and a load on assembly can be reduced because it takes less time to select the resistors.

In this embodiment, the resistor 451 is connected to an anode side of the photo emitter 452a. However, the resistor 451 may be connected to a cathode side of the photo emitter 452a. Since also such a configuration can adjust an electric current flowing through the photo emitter 452a, it is possible to adjust the sensitivity in the same manner as described above.

Further, the resistor may be connected to an emitter side of the photo receiver 452b instead of the photo emitter 452a. With such a configuration, the sensitivity can be adjusted by increasing an activation resistance of the photo receiver 452b. Also, the sensitivity can also be adjusted by connecting the resistor to a collector side of the photo receiver 452b instead of the emitter side.

In this embodiment, while the first group, in which an electric current Ic flowing through the photo receiver 452b is less than 0.75 mA, is omitted because of being low in sensitivity. However, the optical sensor elements 452 belonging to the first group may be made usable by setting a resistance of the resistor 60 small to thereby increase If flowing through the photo emitter 452a to achieve an improvement in element sensitivity. In this case, for example, the first group may be used in a state, In which the resistor 451 is not connected, and the second to fifth groups may be used by connection of the resistor 451 corresponding to the respective groups for a decrease in sensitivity.

In this embodiment, while the classification is performed according to sensitivity and resistors are selected corresponding to the respective groups. However, resistors may be selected and connected according to sensitivity instead of performing the classification.

Further, a resistance may be set according to measurement results in STEP S10 by connection of not a resistor being fixed in resistance like a chip resistor but a resistor being variable in resistance like a variable resistor. In this case, a mark or the like indicating the group described above may be provided on a variable resistor and an adjustment knob may be set in a position corresponding to that group, to which the optical sensor element 452 belongs, with reference to the mark.

In this embodiment, the optical sensor element 452 and the resistor 451 are arranged on the printed board 500 to form the optical sensor 45 as shown in FIG. 9. However, the resistor 451 may be connected directly to a part of the optical sensor element 452. With such construction, the optical sensor 45 can be further downsized.

In this embodiment, the optical sensor 45 is incorporated in the printing apparatus 10. However, the optical sensor 45 may be incorporated in another apparatus with suitable purposes.

In this embodiment, the sensitivity in the case where an electric current if flowing through the photo emitter 452a is 20 mA is measured as shown in FIG. 5. However, the measurement condition may be suitably changed.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A method of manufacturing an optical sensor, comprising:
measuring a sensitivity of a sensor element comprising a photo emitter operable to emit light and a photo receiver operable to output a current in accordance with an amount of received light;
selecting a resistor in accordance with the measured sensitivity; and
connecting the resistor to a circuit operable to drive the optical sensor.

2. The method as set forth in claim 1, wherein:
the sensitivity is measured by measuring the current when the photo emitter emits the light under a predetermined condition.

3. The method as set forth in claim 1, further comprising:
classifying the sensor element into one of a plurality of groups in accordance with the measured sensitivity, wherein:
each of the groups is associated with one resistance; and
the resistor is so selected as to have the resistance associated with one of the group to which the sensor element is classified.

4. The method as set forth in claim 1, wherein:
the resistor Is connected to the photo emitter in series.

5. The method as set forth in claim 1, wherein:
the sensor element and the resistor is mounted on a printed board on which the circuit is formed.

6. An optical sensor, manufactured by the method as set forth in claim 1.
